(19) United States
(12) Patent Application Publication
(10) Pub. No.: US 2021/0382781 A1
(43) Pub. Date: Dec. 9, 2021

(54) CONTROL DEVICE, NON-TRANSITORY STORAGE MEDIUM, AND SYSTEM

(71) Applicant: KABUSHIKI KAISHA TOKAI RIKA DENKI SEISAKUSHO, Aichi (JP)

(72) Inventors: Yosuke HASEGAWA, Aichi (JP); Yosuke OHASHI, Aichi (JP); Takanori MATSUYAMA, Aichi (JP)

(73) Assignee: KABUSHIKI KAISHA TOKAI RIKA DENKI SEISAKUSHO, Aichi (JP)

(21) Appl. No.: 17/238,831

(22) Filed: Apr. 23, 2021

(30) Foreign Application Priority Data
Jun. 4, 2020 (JP) 2020-097780

(51) Int. Cl. G06F 11/07; G06F 9/48

(52) U.S. Cl. CPC G06F 11/0793; G06F 9/4812; G06F 11/0751; G06F 11/0724

(57) ABSTRACT

To manage a series of processes performed by a plurality of devices more efficiently.

There is provided a control device comprising: a control unit configured to transmit an execution instruction to execute a prescribed process which is a process prescribed in advance to at least one of processing devices and cause the plurality of processing devices including the processing device to execute the prescribed process, wherein, when the control unit detects that an error has occurred in execution of the prescribed process executed by one of the plurality of processing devices, the control unit executes control such that an interruption instruction to interrupt the execution of the prescribed process reaches at least one of the processing devices different from the processing device in which the error has occurred.

### CROSS REFERENCE TO RELATED APPLICATIONS

This application is based upon and claims benefit of priority from Japanese Patent Application No. 2020-097780 filed on Jun. 4, 2020, the entire contents of which are incorporated herein by reference.

### BACKGROUND

The present invention relates to a control device, a non-transitory storage medium, and a system.

In recent years, many systems operating by cooperation of a plurality of devices have been developed. For example, Japanese Unexamined Patent Application Publication No. 2019-193112 discloses a system that includes a master and a plurality of slaves.

### SUMMARY

Incidentally, in the foregoing system, when a plurality of devices execute processes in order and an error occurs in any device, the processes performed by the other devices after the occurrence of the error are wasted, which increases the overall processing time in some cases.

Accordingly, the present invention has been devised in view of the foregoing problem and an objective of the present invention is to manage a series of processes performed by a plurality of devices more efficiently.

To solve the above described problem, according to an aspect of the present invention, there is provided a control device comprising: a control unit configured to transmit an execution instruction to execute a prescribed process which is a process prescribed in advance to at least one of processing devices and cause the plurality of processing devices including the processing device to execute the prescribed process, wherein, when the control unit detects that an error has occurred in execution of the prescribed process executed by one of the plurality of processing devices, the control unit executes control such that an interruption instruction to interrupt the execution of the prescribed process reaches at least one of the processing devices different from the processing device in which the error has occurred.

To solve the above described problem, according to another aspect of the present invention, there is provided a non-transitory storage medium that stores a program causing a computer to execute a control function of transmitting an execution instruction to execute a prescribed process which is a process prescribed in advance to at least one of processing devices and causing the plurality of processing devices including the processing device to execute the prescribed process, wherein, when it is detected that an error has occurred in execution of the prescribed process executed by one of the plurality of processing devices, the control function is caused to execute control such that an interruption instruction to interrupt the execution of the prescribed process reaches at least one of the processing devices different from the processing device in which the error has occurred.

To solve the above described problem, according to another aspect of the present invention, there is provided a system comprising: a first control device configured to transmit an execution instruction to execute a prescribed process which is a process prescribed in advance; a second control device configured to execute the prescribed process based on the execution instruction received from the first control device and relay the execution instruction; and at least one processing device configured to execute the prescribed process based on the execution instruction relayed by the second control device, wherein, when the second control device detects that an error has occurred in the execution of the prescribed process executed by the second control device or one processing device, the second control device executes control such that an interruption instruction to interrupt the execution of the prescribed process reaches the second control device or at least one processing device in which the error has occurred.

According to the present invention, as described above, it is possible to provide a structure capable of managing a series of processes by a plurality of devices more efficiently.

### BRIEF DESCRIPTION OF THE DRAWINGS

FIG. 1 is a block diagram illustrating a configuration example of a system according to an embodiment of the present invention.

FIG. 2 is a block diagram illustrating a configuration example of a first control device according to the embodiment.

FIG. 3 is a block diagram illustrating a configuration example of a second control device according to the embodiment.

FIG. 4 is a block diagram illustrating a configuration example of a processing device according to the embodiment.

FIG. 5 is a sequence diagram illustrating an example of a flow of a process of a system that does not execute control in response to an interruption instruction according to the embodiment.

FIG. 6 is a sequence diagram illustrating an example of a flow of a process of a system according to the embodiment.

### DETAILED DESCRIPTION OF THE EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. Configuration Example of System

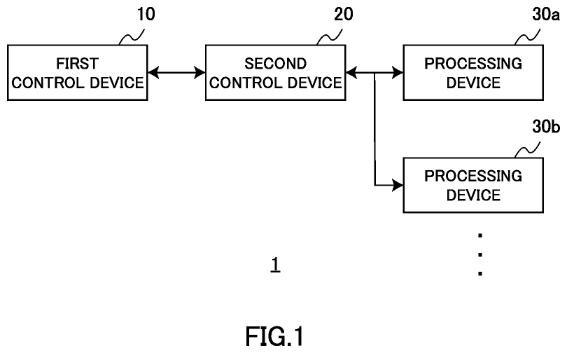

First, a configuration example of a system 1 according to an embodiment of the present invention will be described. FIG. 1 is a block diagram illustrating a configuration example of the system 1 according to the embodiment of the present invention. As illustrated in FIG. 1, the system 1 according to the embodiment includes a first control device 10, a second control device 20, and a plurality of processing devices 30. In FIG. 1, the system 1 that includes at least two processing devices 30a and 30b is exemplified.

### (First Control Device 10)

The first control device 10 according to the embodiment generally controls devices mounted on a casing on which the system 1 is mounted. Examples of control target devices of the first control device 10 are the second control device 20 or the processing devices 30 included in the system 1. For example, in control of the system 1, the first control device 10 according to the embodiment may generate an execution instruction to execute a prescribed process which is a process prescribed in advance and transmit the execution instruction to the second control device 20.

The first control device 10 may set devices other than the devices included in the system 1 as control targets. For example, it is assumed that the casing is a moving object such as a vehicle and the system 1 is a system that causes the moving object to realize a wireless communication function. In this case, the first control device 10 may execute control related to opening and shutting of doors of a moving object, starting of an engine, or the like.

### (Second Control Device 20)

The second control device 20 according to the embodiment is a device that executes the foregoing prescribed process based on the execution instruction received from the first control device 10. From this viewpoint, the second control device 20 can be regarded as one processing device in the present invention.

The second control device 20 according to the embodiment has a function of relaying the execution instruction received from the first control device 10. Specifically, the second control device 20 transmits the received execution instruction to the processing device 30 directly connected via a network.

Here, the direct connection via a network is connection between two devices in which information can be directly transmitted and received without other devices (excluding network devices such as hubs or switches) being interposed therebetween. For example, in the case of the example illustrated in FIG. 1, the second control device 20 and the processing device 30a, and the second control device 20 and the processing device 30b are connected without other devices being interposed therebetween. Therefore, the second control device 20 and the processing device 30a, and the second control device 20 and the processing device 30b can be said to be directly connected.

### (Processing Device 30)

The processing device 30 according to the embodiment is a device that executes the prescribed process based on the received execution instruction. For example, as illustrated in FIG. 1, when each of the processing devices 30a and 30b is directly connected to the second control device 20, each of the processing devices 30a and 30b executes the prescribed process based on the execution instruction received from the second control device 20.

On the other hand, the connection between the second control device 20 and the processing device 30 is not limited to a direct connection. For example, unlike the case exemplified in FIG. 1, it is assumed that the second control device 20 is directly connected to the processing device 30a, the processing device 30a is directly connected to the processing device 30b, and the second control device 20 is not directly connected to the processing device 30b, that is, the processing device 30b is connected to the second control device 20 with the processing device 30a interposed therebetween. In this case, the second control device 20 can be said to be indirectly connected to the processing device 30b.

In this case, the processing device 30a relays the execution instruction received from the second control device 20 to transmit the execution instruction to the processing device 30b. The processing device 30b executes the prescribed process based on the execution instruction received from the processing device 30a.

In this way, the processing device 30 according to the embodiment executes the prescribed process based on the execution instruction generated by the first control device 10 and relayed by the second control device 20 or another processing device 30b. The processing device 30 according to the embodiment returns an execution result (for example, a normal end or occurrence of an error) of the prescribed process to the device receiving the execution instruction.

For example, in the case exemplified in FIG. 1, the processing devices 30a and 30b return the execution result of the prescribed process to the second control device 20. In this case, the second control device 20 returns the execution result of its own prescribed process to the first control device 10 and relays the execution results of the prescribed process executed by the processing devices 30a and 30b to transmit the execution results to the first control device 10.

As in the above-described example, on the other hand, it is assumed that the processing device 30a is directly connected to the second control device 20 and the processing device 30b is indirectly connected to the second control device 20 with the processing device 30a interposed therebetween. In this case, the processing device 30b returns the execution result of the prescribed process to the processing device 30a. The processing device 30a returns the execution result of the own prescribed process to the second control device 20 and relays the execution result of the prescribed process executed by the processing device 30b to transmit the execution result to the second control device 20. The second control device 20 returns the execution result of the own prescribed process to the first control device 10 and relays the execution results of the prescribed processes by the processing devices 30a and 30b to transmit the execution results to the first control device 10.

According to the above-described flow of the information delivery, each of the second control devices 20 and 30 can execute the prescribed process based on the execution instruction generated by the first control device 10. The first control device 10 can receive the execution result of the prescribed process executed by each of the second control device 20 and the processing device 30.

Here, when an error has occurred in the prescribed process executed by any processing device, it is assumed that there are conditions such as necessity for all the processing devices to execute the prescribed process again after a cause of the error is excluded. In this case, the prescribed processes by the other processing devices after the occurrence of the error are wasted, which increases the overall processing time.

The technical ideas according to the present invention were conceived according to the above and allow efficient management of a series of processes by the plurality of devices. Therefore, when either the first control device 10 or the second control device 20 according to an embodiment of the present invention detects that an error has occurred in execution of the prescribed process executed by one of the processing devices, the control device executes control such that an interruption instruction to interrupt the execution of the prescribed process reaches at least one of the processing devices different from the processing device in which the error has occurred. Hereinafter, a configuration of each device included in the system 1 will be described in detail.

### 1.2. Configuration Example of First Control Device 10

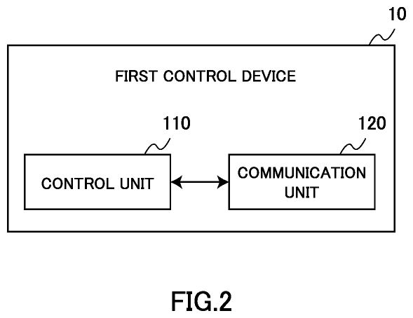

First, a configuration example of the first control device 10 according to the embodiment will be described. The first control device 10 is an example of a control device according to the present invention. FIG. 2 is a block diagram illustrating a configuration example of the first control device 10 according to the embodiment. As illustrated in FIG. 2, the first control device 10 according to the embodiment includes a control unit 110 and a communication unit 120.

### (Control Unit 110)

The control unit 110 according to the embodiment controls an operation of each device included in a casing on which the system 1 is mounted. In particular, in the system 1, the control unit 110 causes the plurality of the processing devices including the second control device 20 and at least one processing device 30 to execute the prescribed process by generating the execution instruction to execute the prescribed process and transmitting the execution instruction to the second control device 20 via the communication unit 120. An example of the prescribed process includes a registration process necessary for a cooperation operation between the first control device 10 and the processing device.

When the control unit detects that an error has occurred in execution of the prescribed process executed by either the second control device 20 or the processing device 30, the control unit 110 according to the embodiment may generate an interruption instruction to interrupt the execution of the prescribed process and may perform control such that the interruption instruction reaches at least one of the processing devices different from the processing device in which the error has occurred. More specifically, the control unit 210 may perform control such that the interruption instruction reaches at least one of the processing devices which have not completed the prescribed process (before the execution or before the end). In this way, by causing the interruption instruction to reach the processing devices in which an error has not occurred, it is possible to avoid the wasted execution of the prescribed process and efficiently shorten a time necessary to execute the series of processes again. The function of the control unit 110 is realized by any of various processors.

### (Communication Unit 120)

The communication unit 120 according to the embodiment executes information communication with respect to the second control device 20 based on the control of the control unit 110. For example, the communication unit 120 transmits the execution instruction or the interruption instruction generated by the control unit 110 to the second control device 20. For example, the communication unit 120 receives an execution result of the prescribed process executed by the second control device 20 or the processing device 30 from the second control device 20.

The functional configuration example of the first control device 10 according to the embodiment will be described above. The foregoing configuration described with reference to FIG. 2 is merely exemplary and the configuration of the first control device 10 according to the embodiment is not limited to the example. The configuration of the first control device 10 according to the embodiment can be flexibly modified in accordance with specifications or administration.

### 1.3. Configuration Example of Second Control Device 20

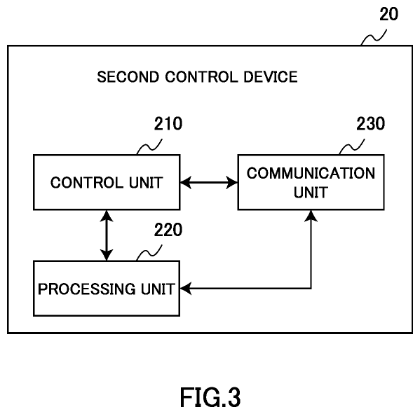

Next, a configuration example of the second control device 20 according to the embodiment will be described. The second control device 20 is an example of the control device according to the present invention. The second control device 20 is an example of a processing device according to the embodiment. FIG. 3 is a block diagram illustrating a configuration example of the second control device 20 according to the embodiment. As illustrated in FIG. 3, the second control device 20 according to the embodiment includes a control unit 210, a processing unit 220, and a communication unit 230.

### (Control Unit 210)

The control unit 210 according to the embodiment controls an operation of the directly or indirectly connected processing device 30. For example, the control unit 210 relays the execution instruction transmitted by the first control device 10 to at least one of the processing devices 30 via the communication unit 230 and causes the plurality of processing devices including the processing device 30 and the processing unit 220 to execute the prescribed process. The control unit 210 transmits an execution result of the prescribed process executed by each of the plurality of processing devices to the first control device 10 via the communication unit 230.

When the control unit 210 according to the embodiment detects that an error has occurred in the execution of the prescribed process in one of the plurality of processing devices, the control unit 210 generates an interruption instruction to interrupt the execution of the prescribed process and executes control such that the interruption instruction reaches at least one of the processing devices different from the processing device in which the error has occurred. More specifically, the control unit 210 may perform control such that the interruption instruction reaches at least one of the processing devices which have not completed the prescribed process (before the execution or before the end). In this way, by causing the interruption instruction to reach the processing devices in which an error has not occurred, it is possible to avoid the wasted execution of the prescribed process and efficiently shorten a time necessary to execute the series of processes again.

When the control unit 210 according to the embodiment detects that an error has occurred in the execution of the prescribed process executed by the processing unit 220 or one of the processing devices, the control unit 210 transmits information regarding the error to the first control device 10 (which is referred to as another device in some cases) via the communication unit 230. Example of the information regarding the error include information indicating that an error has occurred, information indicating content of the occurring error, and information indicating the processing device in which the error has occurred. For example, an operator can take countermeasures for the occurring error earlier, such as exchange of the processing device in which the error has occurred or the like by acquiring the foregoing information via the first control device 10. The function of the control unit 210 is realized by, for example, a processor such as a GPU.

### (Processing Unit 220)

The processing unit 220 according to the embodiment receives the execution instruction transmitted by the first control device 10 via the communication unit 230 and executes the prescribed process based on the execution instruction. When the processing unit 220 receives the interruption instruction after reception of the execution instruction and the prescribed process has not yet completed (before the execution or before the end), the processing unit 220 interrupts the prescribed process. The function of the processing unit 220 is realized by, for example, a processor such as a GPU.

### (Communication Unit 230)

The communication unit 230 according to the embodiment executes information notification with the first control device 10 or the processing device 30 under the control of the control unit 210. Here, in the information communication between the communication unit 230 and the processing device 30, a predetermined communication standard for executing information transmission at a prescribed transmission timing may be adopted. In this case, the control unit 210 transmits the execution instruction to the plurality of processing devices 30 at the prescribed transmission timing via the communication unit 230. In this case, there is a high possibility of a timing at which each processing device 30 receives the execution instruction and a timing at which the prescribed process is executed deviating. Therefore, at a time point at which the error has occurred in the prescribed process in a certain processing device 30, it is expected that the advantage of the interruption instruction according to the embodiment will be more effective because of a scenario in which the other processing devices 30 have not executed the prescribed process. An example of the predetermined communication standard includes a local interconnect network (LIN). The information communication between the communication unit 230 and the first control device 10 is not limited to the predetermined communication standard and another communication standard may be adopted.

The functional configuration example of the second control device 20 according to the embodiment has been described above. The foregoing configuration described with reference to FIG. 3 is merely exemplary and the configuration of the second control device 20 according to the embodiment is not limited to the example. The configuration of the second control device 20 according to the embodiment can be flexibly modified in accordance with specifications or administration.

### 1.4. Configuration Example of Processing Device 30

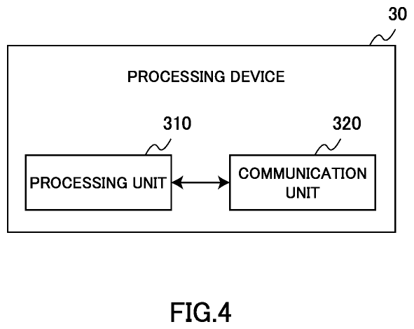

Next, a configuration example of the processing device 30 according to the embodiment will be described. The processing device 30 is an example of a processing device according to the invention. FIG. 4 is a block diagram illustrating a configuration example of the processing device 30 according to the embodiment. As illustrated in FIG. 4, the processing device 30 according to the embodiment includes a processing unit 310 and a communication unit 320.

### (Processing Unit 310)

The processing unit 310 according to the embodiment receives the execution instruction transmitted by the second control device 20 or another processing device 30 via the communication unit 320 and executes the prescribed process based on the execution instruction. The processing unit 310 transmits an execution result of the prescribed process to the device that has received the execution instruction via the communication unit 320. The processing unit 310 interrupts the prescribed process when the interruption instruction is received after reception of the execution instruction and the prescribed process has not completed (before the execution or before the end).

### (Communication Unit 320)

The communication unit 320 according to the embodiment performs information communication with the second control device 20 or another processing device 30. The above-described predetermined communication standard may be adopted in the foregoing information communication.

The functional configuration example of the processing device 30 according to the embodiment has been described above. The foregoing configuration described with reference to FIG. 4 is merely exemplary and the configuration of the processing device 30 according to the embodiment is not limited to the example. The configuration of the processing device 30 according to the embodiment can be flexibly modified in accordance with specifications or administration.

### 1.5. Flow of Process

Next, a flow of the process executed by the system 1 according to the embodiment will be described in detail. First, a flow of a process of a system 7 that does not execute control in response to an interruption instruction according to the embodiment will be described as a contrast. Here, the system 7 is assumed to include a first control device 70 corresponding to the first control device 10, a second control device 80 corresponding to the second control device 20, and processing devices 90a and 90b corresponding to the processing devices 30a and 30b according to the embodiment. In the system 7, each of the processing devices 90a and 90b is assumed to be directly connected to the second control device 80.

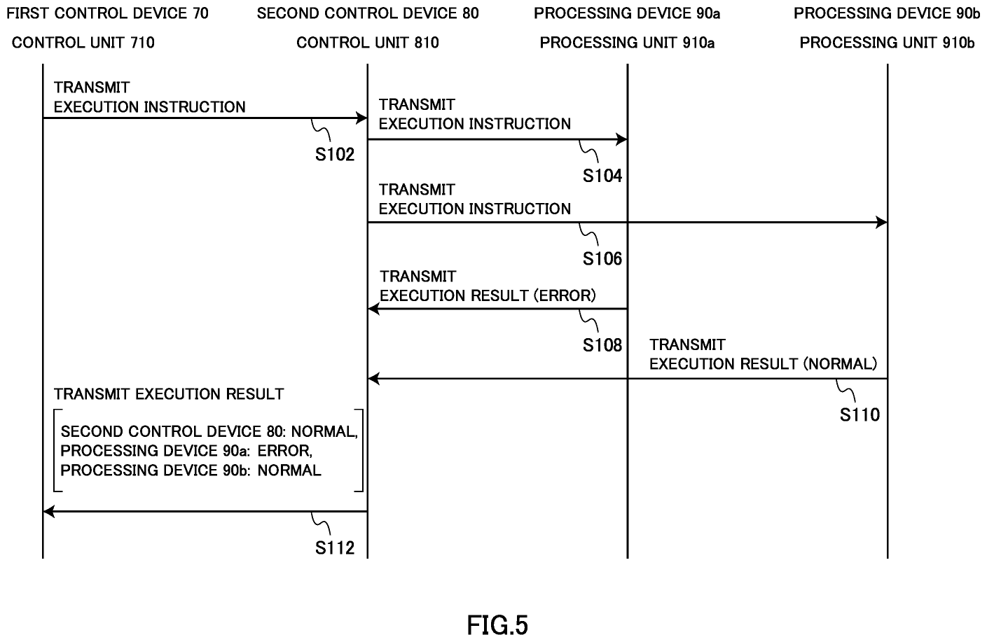

FIG. 5 is a sequence diagram illustrating an example of a flow of a process of the system 7 that does not execute control in response to an interruption instruction according to the embodiment. As illustrated in FIG. 5, in the system 7, the control unit 710 of the first control device 70 first transmits the execution instruction to the second control device 80 via a communication unit 720 (not illustrated) (S102).

Subsequently, a control unit 810 of the second control device 80 receiving the execution instruction in step S102 relays the execution instruction. Specifically, the control unit 810 of the second control device 80 transmits the execution instruction to the processing device 90a at a transmission timing defined in a predetermined communication standard via a communication unit 830 (not illustrated) (S104) and transmits the execution instruction to the processing device 90b (S106).

The control unit 810 of the second control device 80 causes a processing unit 820 (not illustrated) to execute the prescribed process based on the execution instruction received in step S102.

A processing unit 910a of the processing device 90a and a processing unit 910b of the processing device 90b execute the prescribed process based on the execution instruction received from the second control device 80 and return the execution result of the prescribed process to the second control device 80.

For example, in the case of the example illustrated in FIG. 5, the processing unit 910a of the processing device 90a executes the prescribed process based on the execution instruction received from the second control device 80 in step S104 and transmits an execution result indicating that the error has occurred in the prescribed process to the second control device 80 via a communication unit 920a (not illustrated) (S108).

In the case of the example illustrated in FIG. 5, the processing unit 910b of the processing device 90b executes the prescribed process based on the execution instruction received from the second control device 80 in step S106 and transmits an execution result indicating that the prescribed process normally ends to the second control device 80 via a communication unit 920b (not illustrated) (S110).

Subsequently, the control unit 810 of the second control device 80 transmits an execution result (normal) of the prescribed process of the processing unit 820 based on the execution instruction received in step S102, an execution result (an error) of the prescribed process executed by the processing device 90a received in step S108, and an execution result (normal) of the prescribed process executed by the processing device 90b received in step S110 together to the first control device 70 (S114).

In the flow of the foregoing process in the system 7, the second control device 80, the processing device 90a, and the processing device 90b can be caused to execute the prescribed process based on the execution instruction generated by the first control device 70 to acquire results of the prescribed process executed by each device.

However, in the example illustrated in FIG. 5, the second control device 80 waits for reception of the execution result of the prescribed process executed by the processing device 90b in step S110 without transmitting the interruption instruction to the processing device 90b after detecting that an error has occurred in the prescribed process executed by the processing device 90a in step S106, and then transmits the execution results of the prescribed processes by the respective devices together to the first control device 70.

In this case, when the processing device 90b starts or continues an unnecessary prescribed process, a time necessary until re-execution of the series of processes may increase.

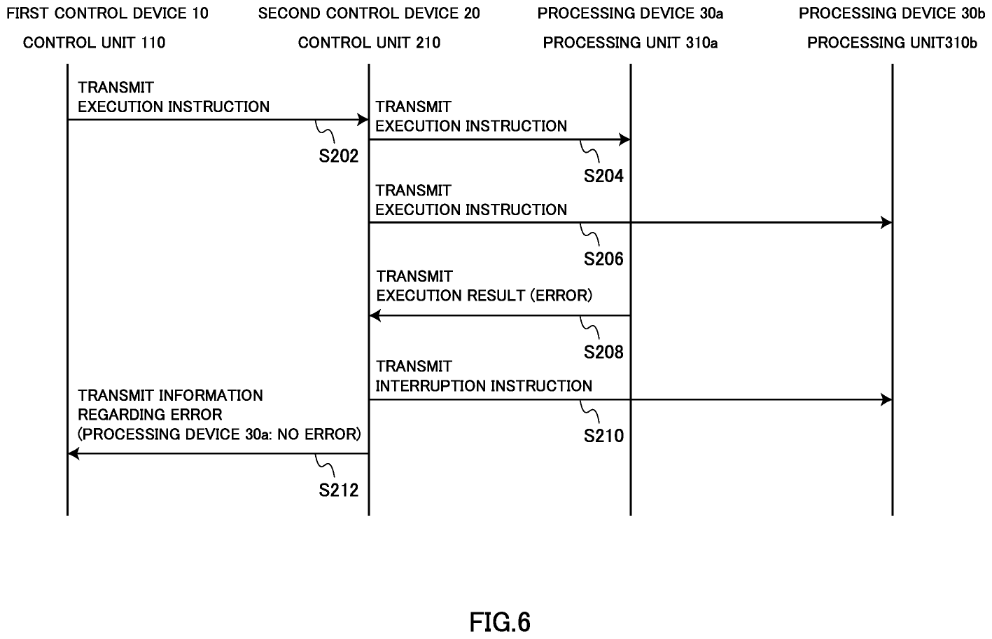

On the other hand, FIG. 6 is a sequence diagram illustrating an example of a flow of a process of the system 1 according to the embodiment. In FIG. 6, each of the processing devices 30a and 30b is assumed to be directly connected to the second control device 20.

As illustrated in FIG. 6, in the system 1, the control unit 110 of the first control device 10 first transmits the execution instruction to the second control device 20 via the communication unit 120 (not illustrated) (S202).

Subsequently, the control unit 210 of the second control device 20 receiving the execution instruction in step S202 relays the execution instruction. Specifically, the control unit 210 of the second control device 20 transmits the execution instruction to the processing device 30a at a transmission timing defined in a predetermined communication standard via the communication unit 230 (not illustrated) (S204) and transmits the execution instruction to the processing device 30b (S206).

The control unit 210 of the second control device 20 causes the processing unit 220 (not illustrated) to execute the prescribed process based on the execution instruction received in step S202.

Here, when the control unit 210 of the second control device 20 according to the embodiment detects that an error has occurred in any prescribed process executed by each processing device, the control unit 210 executes control such that the interruption instruction reaches at least one of the processing devices different from particularly the processing device which has not completed the prescribed process and is different from the processing device in which an error has occurred.

In the case of the example illustrated in FIG. 6, the processing unit 310a of the processing device 30a executes the prescribed process based on the execution instruction received from the second control device 20 in step S204 and transmits an execution result indicating that the error has occurred in the prescribed process to the second control device 20 via a communication unit 320a (not illustrated) (S208).

In this case, the control unit 210 of the second control device 20 detects that the error has occurred in the execution of the prescribed process executed by the processing device 30a based on the execution result received in step S208. The control unit 210 generates the interruption instruction and executes control such that the interruption instruction reaches the processing devices different from the processing device 30a in which the error has occurred.

Specifically, as illustrated, the control unit 210 may control the communication unit 230 such that the interruption instruction is transmitted to the processing device 30b in which the prescribed process has not completed (S210). The control unit 210 may consider that the processing device 30b has not completed the prescribed process based on the fact that the execution result of the prescribed process is not received from the processing device 30b. Here, when the processing unit 220 has not completed the prescribed process, the control unit 210 may input the interruption instruction to the processing unit 220.

The control unit 210 transmits information regarding the detected error to the first control device 10 via the communication unit 230 (S212). In the case of the example illustrated in FIG. 5, the control unit 210 transmits information indicating the processing device (the processing device 30a) in which the error has occurred and information indicating content (no error) of the error as information regarding the error.

The example of the flow of the process executed by the system 1 according to the embodiment has been described above. In the control in which the foregoing interruption instruction is used, when it is detected that an error has occurred in the prescribed process executed by a certain processing device, the other processing devices which have not completed the prescribed process can interrupt the prescribed process which is scheduled to be executed in future and the prescribed process which is being executed. Thus, it is possible to avoid the wasted execution of the prescribed process and effectively shorten a time necessary to execute the series of processes again.

As exemplified in FIG. 6, the control unit 210 executes the control such that the interruption instruction is transmitted to the processing device 30b directly connected to the second control device 20. However, the control unit 210 according to the embodiment can also execute control such that the interruption instruction reaches the processing device indirectly connected to the second control device 20. For example, it is assumed that the processing device 30a is connected directly to the second control device 20 and the processing device 30b is connected indirectly to the second control device 20 with the processing device 30a interposed therebetween. Here, when the control unit 210 detects that an error has occurred in the prescribed process executed by the processing device 30a, the control unit 210 can transmit the interruption instruction to the processing device 30a via the communication unit 230 and can execute control such that the processing device 30a relays the interruption instruction to the processing device 30b.

As exemplified in FIG. 6, the control unit 210 of the second control device 20 generates the interruption instruction. However, the control unit 110 of the first control device 10 may generate the interruption instruction according to the embodiment. In this case, the control unit 110 of the first control device 10 may generate the interruption instruction based on the information regarding the error received from the second control device 20 and cause the second control device 20 to relay the interruption instruction so that the interruption instruction reaches the processing device 30b.

### <Supplements>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

The series of processes by the devices described in the present specification may be realized using any of software, hardware, and a combination of software and hardware. A program of software is stored in advance in, for example, a recording medium (a non-transitory medium) provided inside or outside of each device. Each program is read to a RAM and executed by a processor such as a CPU when the program is executed by a computer. The recording medium is, for example, a magnetic disk, an optical disc, a magneto-optical disc, or a flash memory. The computer program may be delivered via, for example, a network without using a recording medium.

What is claimed is:

1. A control device comprising:
a control unit configured to transmit an execution instruction to execute a prescribed process which is a process prescribed in advance to at least one of processing devices and cause the plurality of processing devices including the processing device to execute the prescribed process,
wherein, when the control unit detects that an error has occurred in execution of the prescribed process executed by one of the plurality of processing devices, the control unit executes control such that an interruption instruction to interrupt the execution of the prescribed process reaches at least one of the processing devices different from the processing device in which the error has occurred.

2. The control device according to claim 1, wherein, when the control unit detects that an error has occurred in the execution of the prescribed process in one of the plurality of processing devices, the control unit executes control such that the interruption instruction reaches at least one of the processing devices which have not completed the prescribed process.

3. The control device according to claim 1, further comprising:
a processing unit configured to receive the execution instruction transmitted by another device and execute the prescribed process based on the execution instruction,
wherein, when the control unit relays the execution instruction transmitted by the other device to at least one of the processing devices and detects that an error has occurred in the execution of the prescribed process executed by the processing unit or one of the processing devices, the control unit transmits information regarding the error to the other device.

4. The control device according to claim 3, wherein, when an error has occurred in the execution of the processing unit or one of the processing devices, the control unit transmits information indicating the processing device in which the error has occurred or the control device to the other control device.

5. The control device according to claim 3, wherein the control unit transmits the execution instruction to a plurality of processing devices at a prescribed transmission timing.

6. The control device according to claim 3, wherein the prescribed process includes a registration process necessary to execute a cooperation operation with the other device.

7. A non-transitory storage medium that stores a program causing a computer to execute a control function of transmitting an execution instruction to execute a prescribed process which is a process prescribed in advance to at least one of processing devices and causing the plurality of processing devices including the processing device to execute the prescribed process,
wherein, when it is detected that an error has occurred in execution of the prescribed process executed by one of the plurality of processing devices, the control function is caused to execute control such that an interruption instruction to interrupt the execution of the prescribed process reaches at least one of the processing devices different from the processing device in which the error has occurred.

8. A system comprising:
a first control device configured to transmit an execution instruction to execute a prescribed process which is a process prescribed in advance;
a second control device configured to execute the prescribed process based on the execution instruction received from the first control device and relay the execution instruction; and
at least one processing device configured to execute the prescribed process based on the execution instruction relayed by the second control device,
wherein, when the second control device detects that an error has occurred in the execution of the prescribed process executed by the second control device or one processing device, the second control device executes control such that an interruption instruction to interrupt the execution of the prescribed process reaches the second control device or at least one processing device in which the error has occurred.
